(19) United States
(12) Patent Application Publication
(10) Pub. No.: US 2024/0202246 A1
(43) Pub. Date: Jun. 20, 2024

(54) PRE-PACKAGING SERVICE FOR PARALLEL OBJECT PROCESSING

(71) Applicant: SAP SE, Walldorf (DE)

(72) Inventors: Alexander KOENIG, Heidelberg (DE); Michael HETTICH, Heidelberg (DE); Andre KLAHRE, Angelbachtal (DE)

(21) Appl. No.: 18/066,758

(22) Filed: Dec. 15, 2022

(51) Int. Cl. G06F 16/903; G06F 16/906

(52) U.S. Cl. CPC G06F 16/90335; G06F 16/906

(57) ABSTRACT

Systems and methods include determination of a plurality of objects to be processed, wherein each of the plurality of objects conforms to a same data model, determination of values of one or more attributes associated with each of the plurality of objects, determination of a group for each of the plurality of objects, where each object of a given determined group is associated with same values of the one or more attributes as each other object of the given determined group, assignment of each group to one of a plurality of packages, wherein no two packages are assigned a same group, and processing of each of the plurality of packages in parallel.

### BACKGROUND

Modern system landscapes consist of independent applications provided by several computing systems. It is often desirable for two applications within a system landscape to communicate with one another. However, and especially if the two applications are provided by different application vendors, differences in the structure and content of their logical entities (e.g., database objects) may render such communication difficult.

To address the foregoing, abstractions may be defined as application-agnostic representations of logical entities. To communicate with a second application, a first application may convert an object instance from its application-specific structure to a structure defined by such an abstraction, or “meta domain model”. The second application receives the converted instance, converts the instance of the meta domain model to one or more application-specific object instances, and processes the application-specific object instances.

In a specific example, product data is regularly sent between different Product Lifecycle Management (PLM) systems during different phases of product development. Product data is represented in a PLM system by different objects such as a material object and a Bill of Materials (BOM) object. Meta domain model objects therefore provide generic representations of a material object and a BOM object, which are used as described above for communication between systems whose material and BOM objects differ from one another.

Such integration between two systems can require the processing of very large numbers of objects. This processing can be quite resource- and time-consuming. To reduce the required processing time, in may be considered to process separate subsets of the objects in parallel.

For example, the objects to be processed (i.e., the data set) may be divided into packages of a certain maximum size. Each package is sent to separate logical units of work (LUW), which are running in parallel. However, situations exist in which an object to be processed is linked to other entities. These dependencies can lead to locking issues in a case that multiple objects are linked to the same entity and processed at the same time during parallelization. For example, while LUW 1 updates entity X with a link to a newly-created object A, LUW 2 may attempt to update entity X with a link to the newly-created object B. The update by LUW 2 fails because the entity X is currently being edited by LUW 1.

Systems are desired to facilitate the parallel processing of objects.

### BRIEF DESCRIPTION OF THE DRAWINGS

FIG. 1 is a block diagram of a system to generate packets of objects for parallel processing according to some embodiments.

FIG. 2 is a flow diagram of a process to generate packages of objects for parallel processing according to some embodiments.

FIG. 3 is a table of object identifiers and associated attribute values according to some embodiments.

FIG. 4 is a table of object identifiers and associated attribute values according to some embodiments.

FIGS. 5-11 are tables illustrating grouping of objects and generation of packages therefrom according to some embodiments.

FIG. 12 is a block diagram of a cloud-based architecture according to some embodiments.

### DETAILED DESCRIPTION

The following description is provided to enable any person in the art to make and use the described embodiments. Various modifications, however, will be readily-apparent to those in the art.

According to some embodiments, a set of objects to be processed is divided into two or more groups of objects based on attribute values of the objects. The attribute values are selected such that the groups may be processed in parallel without encountering collisions or locking delays. For example, the objects may be grouped such that objects of one group share no dependencies with objects of any other group. Since the objects of a particular group are processed sequentially, objects within a group may share dependencies without causing collisions or locking during their processing. According to some embodiments, the groups are combined into a plurality of packages, where each package includes one or more unique groups. The packages may then be processed in parallel.

The object attributes based on which the objects are divided into groups may be hard-coded or selected by a user via a customizing entry. The attributes may be selected from fields of the data model of an object or from extension fields thereof. If multiple attributes are selected, the attributes may be considered additively during creation of the groups. Alternatively, creation of the groups may be based on other logical expressions incorporating the multiple selected attributes.

Embodiments may be implemented in any system in which objects to be processed in parallel are associated with criteria by which those objects sharing dependencies may be grouped together.

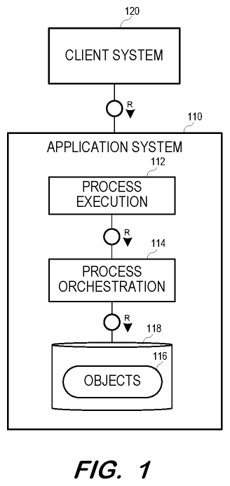

FIG. 1 is a block diagram of application system 110 and client system 120 according to some embodiments. The illustrated elements of FIG. 1 and of all other architectures depicted herein may be implemented using any suitable combination of computing hardware and/or software that is or becomes known. Such combinations may include one or more processing units (microprocessors, central processing units, microprocessor cores, execution threads), one or more non-transitory electronic storage media, and processor-executable program code. In some embodiments, two or more components of application system 110 and client system 120 are implemented by a single computing device. One or more components of application system 110 and client system 120 may be implemented using cloud-based resources, and/or other systems which apportion computing resources elastically according to demand, need, price, and/or any other metric.

Application system 110 may comprise an on-premise server, a cloud-deployed virtual machine, or any other suitable computing system to provide a software-based application/service to clients. Any components of application system 110 may be implemented in a distributed manner. For example, application system 110 may include a plurality of compute nodes (e.g., servers) and a plurality of database nodes.

Storage 118 may comprise one or more volatile and/or non-volatile data storage devices. Storage 118 includes metadata defining data models as is known in the art. A data model may specify data and logic used to represent a logical entity. Objects 116 include the data of particular instances of the logical entities. For example, a product data model may define a product, while objects 116 include several instances of the product data model, each of which corresponds to a particular product. The logical entities of the data models are typically related to the functionality of an application which is intended to process objects 116.

While application system 110 may execute more than one application/service, application system 110 is depicted as including process execution component 112 and process orchestration component 114. Application system 110 executes program code of process execution component 112 and process orchestration component 114 to process objects 116 of data storage 118.

Process execution component 112 and process orchestration component 114 may comprise components of an unshown application (e.g., a PLM application, a data analytics application, a financial processing application). Process execution component 112 may comprise program code for executing at least one application-specific process on different packages of objects 116 in parallel. In one example, the process is to convert the objects 116 of the packages to objects conforming to a data model of a different application. Embodiments do not limit process execution component 112 to any particular process.

Application system 110 may execute program code of process orchestration component 114 to group objects to be processed by process execution component 112 as described herein. Process orchestration component 114 may return identifiers of the grouped objects and their groupings (and/or their packages) to process execution component 112. According to some embodiments, process orchestration component 114 may be used by several different process execution components (possibly belonging to different applications executing on application system 110) to group objects to be processed by the different process execution components.

Client system 120 transmits requests to application system 110. For example, a user may operate client system 120 to execute a Web browser and to input a Uniform Resource Locator (URL) associated with a domain of application system 110. The Web browser issues a request based on the URL and receives a Web page or a browser-executable client application as is known in the art to facilitate communication with application system 110.

According to some embodiments, client system 120 is an application system such as application system 110 which executes an application or service. For example, application system 110 may participate in a microservice architecture (not shown) in which independently-implemented services call one another to generate and return a coordinated result.

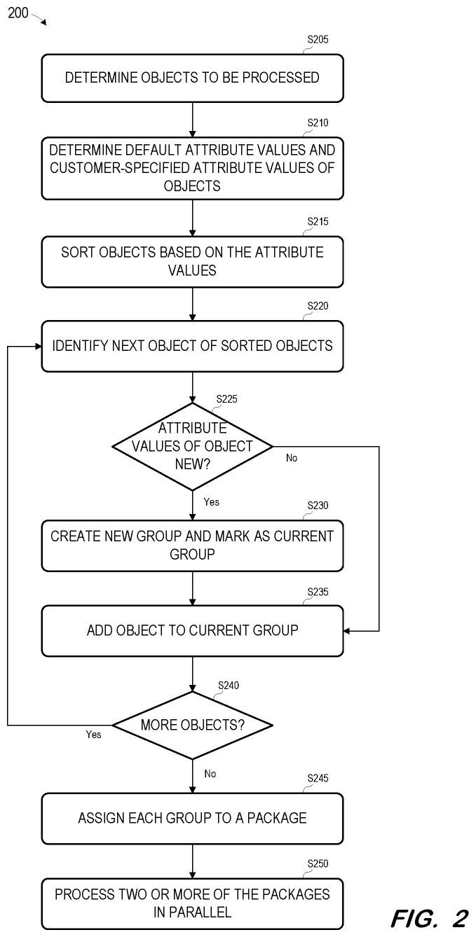

FIG. 2 comprises a flow diagram of a process to generate packages of objects for parallel processing according to some embodiments. Process 200 and all other processes mentioned herein may be embodied in processor-executable program code read from one or more of non-transitory computer-readable media, such as, for example, a hard disk drive, a volatile or non-volatile random access memory, a DVD-ROM, a Flash drive, and a magnetic tape, and then stored in a compressed, uncompiled and/or encrypted format. A processor may include any number of microprocessors, microprocessor cores, processing threads, or the like. In some embodiments, hard-wired circuitry may be used in place of, or in combination with, program code for implementation of processes according to some embodiments. Embodiments are therefore not limited to any specific combination of hardware and software.

Initially, at S205, objects to be processed are determined. For example, an application may determine a number of objects which are to be subjected to the same processing algorithm. The objects may require conversion to a different data model, modification of a particular field, or any other processing. In some embodiments, S205 comprises providing process orchestration component 114 with a list of identifiers of the objects to be processed (e.g., from process execution component 112).

Next, at S210, attribute values of each of the objects are determined. The attributes may be attributes which indicate whether two different objects should be processed in parallel or processed sequentially, for example, to avoid collisions or locking. The attribute values may include values of attributes specified by the processing application (i.e., hard-coded) and/or values of attributes specified by a customer. Accordingly, S210 may comprise determining a customer for whom the objects are to be processed and then determining attributes associated with the customer.

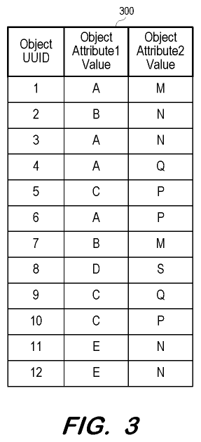

FIG. 3 is a tabular representation of data structure 300 including object identifiers (UUIDs) of objects determined at S205, and their associated attribute values. Data structure 300 may be generated on-the-fly by process orchestration component 114 based on stored objects 116 during process 200 according to some embodiments. In the present example, Object Attribute1 is an attribute specified by the object-processing application and Object Attribute2 is a customer-specified attribute.

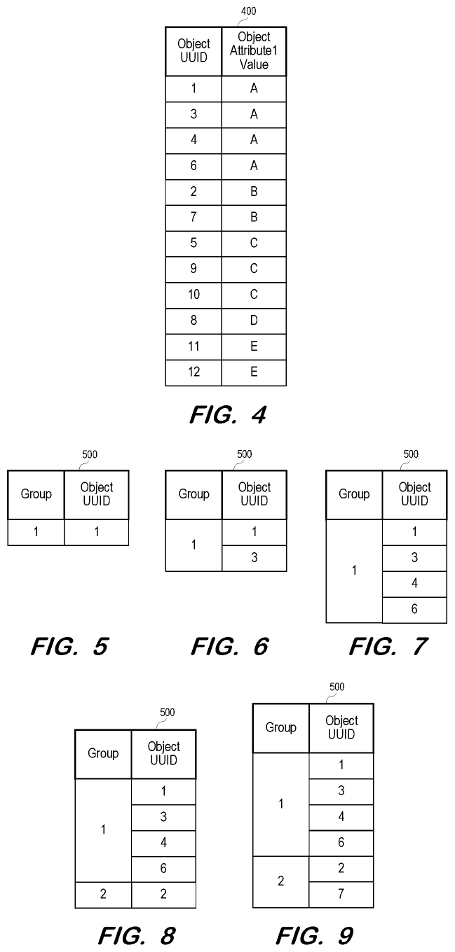

The objects are sorted at S215 based on their associated attribute values. Sorting is not required in some embodiments but may result in faster grouping than alternative implementations. For ease of explanation, data structure 400 of FIG. 4 illustrates an example in which only one attribute (i.e., Object Attribute1) is determined at S210, and in which the objects have been sorted at S215 based on the one attribute.

According to some embodiments, Object Attribute1 is a UUID of a change object associated with the Object UUID. A change object may specify a date after which associated changes represented in a modified object are valid. Accordingly, many objects may be associated with the same change object and processing of each of the many objects may require access to the same change object. It may therefore be beneficial to process all objects associated with a same change object sequentially (i.e., not in parallel).

At S220, a next object of the sorted objects is identified. The identified object is the first object of the sorted objects during the first iteration of S220. Referring to data structure 400, the object identified during the first iteration of S220 is Object UUID 1 in the present example.

At S225, it is determined whether the attribute values of the identified object are new. That is, it is determined whether a group has already been created which is associated with the determined attribute values. Since no groups have been created, flow proceeds to S230 to create a new group and mark the new group as the current group. Next, at S235, the object is added to the current (i.e., newly-created) group.

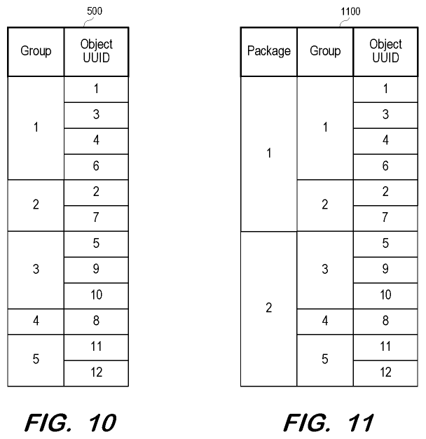

FIG. 5 illustrates data structure 500 according to some embodiments. Data structure 500 may be created by process orchestration component 114. As shown, Group 1 has been created at S230 and Object UUID 1 has been added to Group 1 at S235.

At S240, it is determined whether the sorted objects include more objects. If so, flow returns to S220 to identify a next object of the sorted objects. The next object in the present example is Object UUID 3, which shares the same value of Object Attribute1 as Object UUID 1. Accordingly, the determination at S225 is negative and flow proceeds to S235, where Object UUID 3 is added to the current group (i.e., Group 1). FIG. 6 illustrates data structure 500 after the addition of Object UUID 3 to Group 1 at S235. Flow continues in the above manner to identify Object UUIDs 4 and 6 of data structure 400 and add these UUIDs to Group 1, as shown in FIG. 7.

Next, after another determination at S240 that the sorted objects include more objects, flow returns to S220 to identify Object UUID 2. At S225, it is determined that the value of Object Attribute1 for Object UUID 2 has not yet been encountered by process 200. Therefore, a new group (i.e., Group 2) is created at S230 and the object is added to the new group at S235, (i.e., newly-created). FIG. 8 illustrates data structure 500 after the creation of Group 2 and the addition of Object UUID 2 thereto.

Flow then returns to S220 to identify Object UUID 7, which shares the same value of Object Attribute1 as Object UUID 2. Object UUID 7 is therefore added to the current group (i.e., Group 2) at S235, as depicted in FIG. 9. Process 200 continues to execute in this manner to create Group 3 and add Object UUIDs 5, 9 and 10 to Group 3, to create Group 4 and add Object UUID 8 to Group 4 and to create Group 5 and add Object UUIDs 11 and 12 to Group 5 until it is determined at S240 that no more objects remain in data structure 400. FIG. 10 illustrates data structure 500 at S240 according to some embodiments.

Each of the created groups is assigned to a package at S245. No two packages include a same group. The groups may be assigned to packages based on a desired total size of (e.g., number of objects in) a package, on the attribute values of each group, and/or on any other suitable parameter.

FIG. 11 shows data structure 1100 in which each group is assigned to a package. In particular, Groups 1 and 2 are assigned to Package 1 and Groups 3, 4 and 5 are assigned to Package 2. Even more particularly, Object UUIDs 1, 3, 4, 6, 2 and 7 are assigned to Package 1 and Object UUIDs 5, 9, 10, 8, 11 and 12 are assigned to Package 2.

S245 may be performed by process orchestration component 114 in some embodiments. The packages and corresponding UUIDs may then be returned to process orchestration component 112 to execute the packages in parallel at S250. Since the objects which may exhibit co-dependencies belong to a same package, processing each package in parallel (and processing each object within a package sequentially) may reduce collisions and/or locking and their resulting delay.

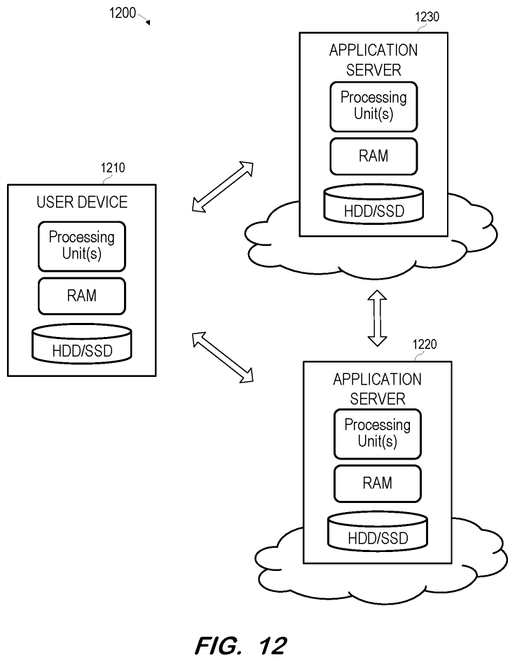

FIG. 12 illustrates cloud-based database deployment 1200 according to some embodiments. In this regard, application servers 1220 and 1230 may comprise cloud-based compute resources, such as virtual machines, allocated by a public cloud provider providing self-service and immediate provisioning, autoscaling, security, compliance and identity management features.

User device 1210 may issue a request to an application executing on application server 1220, for example via a Web Browser executing on user device 1210. The request may be routed to application server 1220 according to Internet protocols. During execution of the application, a process orchestration component as described herein may determine packages of objects to be processed in parallel. Such processing may result in issuance of external calls from application server 1220 to application server 1230, which may similarly use a process orchestration component to determine packages of objects of application server 1230 to be processed in parallel.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of architecture 100 or 900 may include a programmable processor to execute program code such that the computing device operates as described herein.

All systems and processes discussed herein may be embodied in program code stored on one or more non-transitory computer-readable media. Such media may include, for example, a DVD-ROM, a Flash drive, magnetic tape, and solid state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

Embodiments described herein are solely for the purpose of illustration. Those in the art will recognize other embodiments may be practiced with modifications and alterations to that described above.

1. A method comprising:
determining a plurality of objects to be processed;
determining values of one or more attributes associated with each of the plurality of objects;
determining a group for each of the plurality of objects, where each object of a given determined group is associated with same values of the one or more attributes as each other object of the given determined group and no two objects of two different groups are linked to a same entity;
assigning each group to one of a plurality of packages, wherein no two packages are assigned a same group; and
processing each of the plurality of packages in parallel.

2. A method according to claim 1, further comprising:
sorting the plurality of objects based on the associated values of one or more attributes; and
determining the group for each of the plurality of objects based on the sorted plurality of objects.

3. A method according to claim 1, wherein the one or more attributes indicate whether processing of two different objects in parallel may cause collisions or locking delays.

4. A method according to claim 3, wherein the one or more attributes comprise a change object identifier.

5. A method according to claim 4, further comprising:
sorting the plurality of objects based on the associated values of one or more attributes; and
determining the group for each of the plurality of objects based on the sorted plurality of objects.

6. A method according to claim 1, further comprising:
determining a customer associated with the plurality of objects to be processed,
wherein determining the values of one or more attributes comprises determining one or more attributes associated with the customer.

7. A method according to claim 6, wherein the one or more attributes indicate whether processing of two different objects in parallel may cause collisions or locking delays.

8. A non-transitory computer-readable medium storing program code executable by one or more processing units to cause a computing system to:
determine a plurality of objects to be processed, wherein each of the plurality of objects conforms to a same data model;
determine values of one or more attributes associated with each of the plurality of objects;
determine a group for each of the plurality of objects, where each object of a given determined group is associated with same values of the one or more attributes as each other object of the given determined group and no two objects of two different groups are linked to a same entity;
assign each group to one of a plurality of packages, wherein no two packages are assigned a same group; and
process each of the plurality of packages in parallel.

9. A medium according to claim 8, the program code executable by one or more processing units to cause a computing system to:
sort the plurality of objects based on the associated values of one or more attributes; and
determine the group for each of the plurality of objects based on the sorted plurality of objects.

10. A medium according to claim 8, wherein the one or more attributes indicate whether processing of two different objects in parallel may cause collisions or locking delays.

11. A medium according to claim 10, wherein the one or more attributes comprise a change object identifier.

12. A medium according to claim 11, the program code executable by one or more processing units to cause a computing system to:
sort the plurality of objects based on the associated values of one or more attributes; and
determine the group for each of the plurality of objects based on the sorted plurality of objects.

13. A medium according to claim 8, the program code executable by one or more processing units to cause a computing system to:
determine a customer associated with the plurality of objects to be processed,
wherein determination of the values of one or more attributes comprises determining one or more attributes associated with the customer.

14. A medium according to claim 13, wherein the one or more attributes indicate whether processing of two different objects in parallel may cause collisions or locking delays.

15. A system comprising:
one or more storage devices storing a plurality of objects to be processed;
one or more processing units; and
a memory storing program code executable by the one or more processing units to cause the system to:
determine values of one or more attributes associated with each of the plurality of objects;
determine a group for each of the plurality of objects, where each object of a given determined group is associated with same values of the one or more attributes as each other object of the given determined group and no two objects of two different groups are linked to a same entity;
assign each group to one of a plurality of packages, wherein no two packages are assigned a same group; and
process each of the plurality of packages in parallel.

16. A system according to claim 15, the program code executable by the one or more processing units to cause the system to:
sort the plurality of objects based on the associated values of one or more attributes; and
determine the group for each of the plurality of objects based on the sorted plurality of objects.

17. A system according to claim 15, wherein the one or more attributes indicate whether processing of two different objects in parallel may cause collisions or locking delays.

18. A system according to claim 17, the program code executable by the one or more processing units to cause the system to:
sort the plurality of objects based on the associated values of one or more attributes; and
determine the group for each of the plurality of objects based on the sorted plurality of objects.

19. A system according to claim 15, the program code executable by the one or more processing units to cause the system to:
determine a customer associated with the plurality of objects to be processed,
wherein determination of the values of one or more attributes comprises determining one or more attributes associated with the customer.

20. A system according to claim 19, wherein the one or more attributes indicate whether processing of two different objects in parallel may cause collisions or locking delays.
